(19) United States
(12) Patent Application Publication
(10) Pub. No.: US 2007/0018354 A1
(43) Pub. Date: Jan. 25, 2007

(54) Process and apparatus for the production or articles made of plastic material with at least one overmoulded component

(76) Inventors: Maurizio Bazzo, Oderzo (Treviso) (IT); Peter Dal Bo, Vittorio Veneto (Treviso) (IT)

Correspondence Address: HESLIN ROTHENBERG FARLEY & MESITI PC, 5 COLUMBIA CIRCLE, ALBANY, NY, 12203, US

(21) Appl. No.: 11/492,534

(22) Filed: Jul. 24, 2006

(30) Foreign Application Priority Data
Jul. 22, 2005 (IT) TO2005A000507

(51) Int. Cl. B29C 45/14

(52) U.S. Cl. 264/255; 425/112; 264/328.7; 264/328.9

(57) ABSTRACT

Described herein is a process and apparatus for the production of an article made of moulded plastic material including a first component formed in a first step of injection and possible compression, and at least one second component overmoulded on said first component in a second step of injection and possible compression step. The two steps of injection and possible compression are carried out within the same moulding cavity defined between a mould and a countermould in a single station, without any need for displacing the countermould into a second station.

### FIELD OF THE INVENTION

The present invention relates to the production of articles made of moulded plastic material in general, particularly (but not exclusively) plates, with at least one overmoulded component.

The plates to which the invention finds particular (but, as has been said, not exclusive) application may be transparent or not, and also the elements overmoulded thereon may be transparent or not, of the same material as the plates or of a different material. Said elements may be overmoulded in peripheral areas of the plate, for example, along its peripheral edge, or else in different areas.

In any case, the invention is particularly aimed at the production of articles with aesthetic characteristics of high quality, for which the surface in view is conventionally referred to as “class A”.

### STATE OF THE PRIOR ART

Traditional techniques for overmoulding articles of not particularly high quality, or in any case of aesthetic characteristics that are not so high as the ones to which the invention particularly relates, envisage a first injection step to form the first component within a cavity defined between a mould and a countermould, a geometrical variation of the cavity by means of internal movements, and then a second step of injection of the second component for overmoulding thereof on the first component. These operations can be carried out in a single station, without any particular difficulty.

In the case of articles with aesthetic characteristics of high quality and also with relatively large dimensions, such as for example plates for producing transparent panels in the automotive sector, the methodology currently used envisages a first step of injection of the material that is to form the first component within a cavity defined between a mould and a countermould, to which there can be possibly associated a step of compression or else of expansion-compression fundamentally for the purpose of reducing the residual internal stresses of the injected material. This first step is carried out traditionally in a first station: the moulding cavity is then opened and the countermould with the first component is transferred—generally via rotation about a vertical axis or else a horizontal axis—to a second station where a second mould delimits a new cavity for injection (said injection being possibly also combined with a step of compression or expansion-compression) of the material for overmoulding of the second component on the first. A typical example of a moulding apparatus of this type is represented by presses of the “stack-mould” type with double countermould rotating about a vertical axis, as generally described in the document No. DE-A-10217584.

Peculiar solutions for improving the process of moulding implemented with this sort of apparatus, in order to obtain items even of large dimensions with the maximum quality possible, are described and illustrated in the Italian patent applications Nos. T02004A000696, T02004A000697, T02004A000698, T02004A000699, T02004A00700, T02004A000701, T02004A000702, T02004A000703, T02004A000716 and T02004A000813, all filed in the name of the present applicant and not published at the date of priority of the present application.

The overmoulding obtained with technologies of this sort enables particularly robust internal fixing and reinforcement elements to be obtained for the moulded article, without altering the aesthetic characteristics of the outer surface of the article itself. These technologies envisage, as has been said, the moulding of bi-component articles, with rotation of the countermould and consequently always involve a displacement: the first component moulded in the first station is, as has been said, displaced into a second station for moulding of the second component. This involves a considerable complexity of the moulding apparatus and of the corresponding controls, particularly in the case where one or both of the injection steps are co-ordinated with a step of compression or of expansion-compression, as well as involving large overall dimensions of the apparatus.

### SUMMARY OF THE INVENTION

The purpose of the present invention is to provide a process for the production of bi-component (or generally multi-component) articles made of plastic material even of large dimensions and in any case of high aesthetic quality, by means of which it is possible to avoid having to rotate the countermould, after formation of the first component, in order to overmould thereon of the second component by means of a second mould.

According to the invention, the above purpose is achieved thanks to the fact that a process as defined in the preamble of claim 1 is principally characterized in that it is carried out in a single station defined by said mould and said countermould and in that said geometrical variation of the cavity includes a step of recession between said mould and said countermould, obtaining in this way a thickness of the final mould that is different between the first step and the second step.

The geometrical variation of the cavity moreover conveniently includes also the displacement within it of at least one mobile part.

The two injection steps may be steps of just injection, or else one or the other or both of them can be combined with a step of compression or of expansion-compression.

Further characteristics and alternative embodiments of the process are defined in the subordinate claims 5-14.

Also a subject of invention is an apparatus for implementation of the process, defined mainly in claim 15 and, in its secondary characteristics, in claims 16-28 subordinate thereto.

Claims 29 and 30, and the corresponding subclaims, regard a variant of the process and, respectively, of the apparatus expressly regarding the production, in a single station, of an article made of moulded plastic material with a first component and a second component, at least one of which is formed by means of injection-compression.

### BRIEF DESCRIPTION OF THE DRAWINGS

The invention will now be described in detail with reference to the annexed plate of drawings, in which:

FIG. 1 is a schematic dorsal elevation of a bi-component plate of plastic material that can be obtained using the process according to the invention;

FIG. 2 is a cross-sectional view according to the line II-II of FIG. 1;

FIG. 3 is a front elevation of the plate of FIG. 1;

FIG. 4 is a partially sectioned schematic view of a first embodiment of an apparatus for implementation of the process according to the invention, represented in a first operating step;

FIGS. 5, 6 and 7 are three views similar to those of FIG. 4 that illustrate the apparatus in respective successive operating steps;

FIG. 8 is a view similar to that of FIG. 4 that shows a second embodiment of the apparatus for implementation of the process in a first operating step;

FIGS. 9, 10 and 11 are three views similar to those of FIG. 8 that show respective successive operating steps;

FIG. 12 shows at an enlarged scale a detail of the apparatus according to FIG. 8 in the operating step corresponding to that of FIG. 9;

FIG. 13 is a view similar to that of FIG. 12 in the operating step corresponding to that of FIG. 11;

FIGS. 14, 15, 16 and 17 show another variant of the apparatus in the same successive operating steps;

FIGS. 18, 19, 20 and 21 show another variant of the apparatus in the same successive operating steps;

FIGS. 22, 23 and 24 show a detail of a further variant of the apparatus in three respective operating steps;

FIGS. 25, 26 and 27 show a detail of a further variant of the apparatus in three respective successive operating steps;

FIGS. 28, 29 and 30 show a variant of a further detail of the apparatus in three respective successive operating steps;

FIGS. 31 and 32 show schematically a detail of the apparatus in two successive operating steps according to another peculiar aspect of the process according to the invention;

FIGS. 33 and 34 show a variant of FIGS. 31 and 32;

FIG. 35 sets in comparison an article obtainable following upon the steps represented in FIGS. 31 and 32 with a similar article obtained with conventional procedures; and

FIGS. 36 and 37 show a detail of a further variant of the apparatus in two different successive operating steps.

### DETAILED DESCRIPTION OF EMBODIMENTS OF THE INVENTION

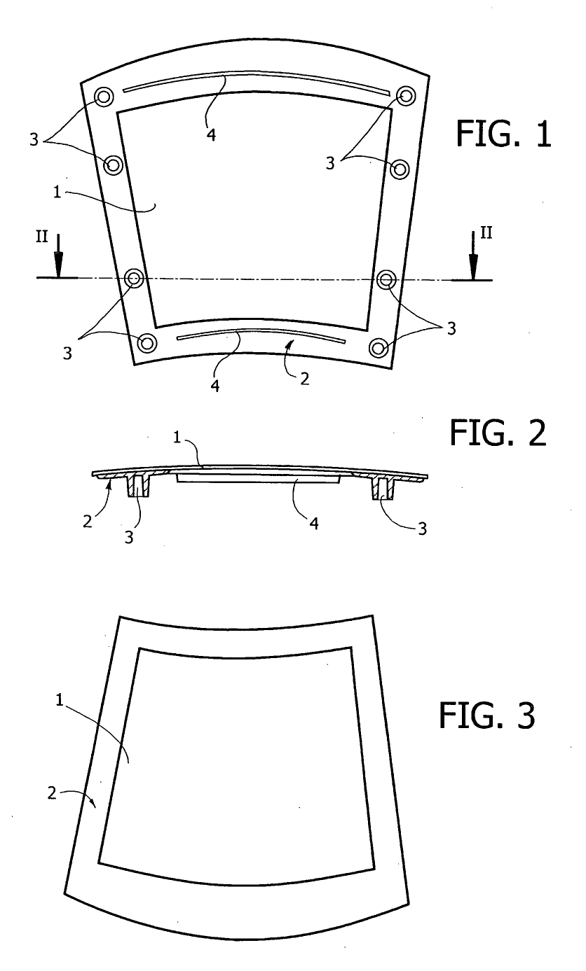

With reference to the drawings, FIGS. 1 to 3 are schematic illustrations of an example of a bi-component article made of plastic material obtained with the process and the apparatus according to the invention. It should be pointed out that the article described hereinafter is illustrated purely by way of non-limiting example, and that the invention is applicable to articles of different shapes and with different characteristics, which include, however, a first component and at least one second component overmoulded on the first, and the surface of which exposed in use to view presents aesthetic characteristics of high quality. The article represented in FIGS. 1 to 3 consists of a roof for use in the automotive sector, constituted by a plate 1 that is normally (but not necessarily) transparent, typically made of polycarbonate, on the dorsal face of which is overmoulded a perimetral frame 2 made of a material that is normally (but not necessarily) non-transparent, for example black in colour, formed with fixing appendages 3 and with possible stiffening projections or ribbings 4.

In what follows the transparent plate 1 and the perimetral frame 2 will be for convenience referred to, respectively, as external component 1 and internal component 2.

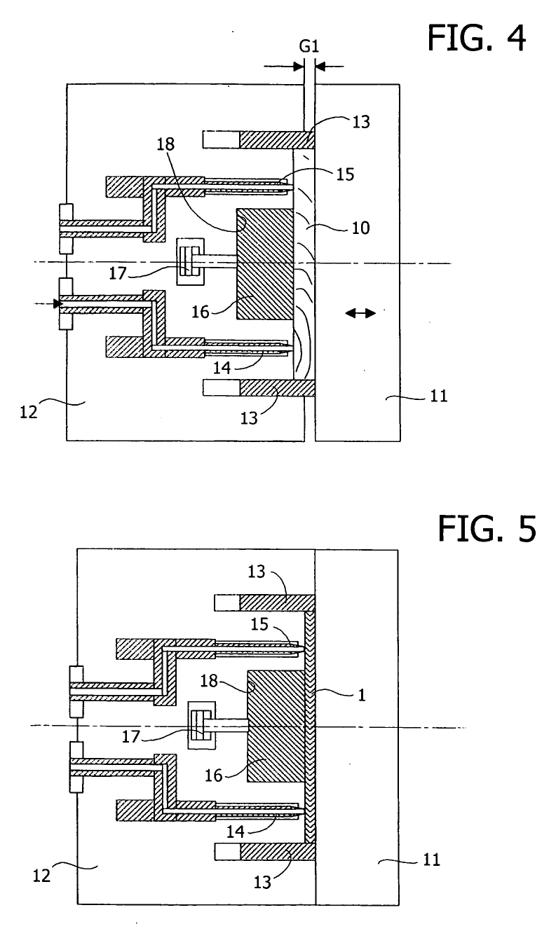

FIG. 4 is a schematic illustration of a possible embodiment of the apparatus for producing an article generally corresponding to that of FIGS. 1 to 3. The more general inventive idea underlying the invention is that of overmoulding the internal component 2 on the external component 1 in a single station, without any need for rotation of the mould about a vertical axis or horizontal axis to bring the previously moulded external component 1 into a subsequent station for overmoulding of the internal component 2, this both in the case where forming of the external component 1 and/or forming by overmoulding of the internal component 2 use/uses methodologies of simple injection, or else of compression or else of expansion-compression combined with the injection of the plastic material. The suppression of a second station for overmoulding the internal component 2, as well as the elimination of the need to transfer the external component 1 from a first station to a second station, enable drastic simplification of the structure of the moulding apparatus and elimination of any problem connected to the coupling between the mould bearing the external component 1 and a second countermould for closing the cavity comprised between them and overmoulding of the internal component 2.

In FIG. 4, the reference number 10 designates the moulding cavity comprised between a mould 12 and a countermould 11, which are translatable with respect to one another. In the case of the example illustrated, the mould 12 can be brought up to and moved away from the countermould 11, which is instead stationary. A number of cavities 10 can be provided.

The cavity 10 is delimited in a generally conventional way by mobile closing ring nuts 13, for example carried by the mould 12, which is equipped with an injection apparatus, which is also generally conventional, comprising one or more injectors 14 for injection within the cavity 10 of the plastic material that is to constitute the external component 1, and one or more injectors 15 for the subsequent injection of the plastic material that is to form the internal component 2.

According to the peculiar aspect of the invention, the configuration of the cavity 10 is geometrically modifiable either as a result of a greater or smaller approach between the mould 12 and the countermould 11 in the conditions of closing of the cavity 10 corresponding to the two successive injection steps or possibly via displacement within it of at least one mobile part, which is normally carried by the mould 12. In the case now described, a single central mobile part 16 is provided, which can be displaced, via a motor-driven actuator 17, for example a fluid actuator or an actuator of some other type, between a set-in position and a position extracted with respect to a front recess 18 formed in the mould 12.

The cycle of operation of the apparatus thus described for the production of the article according to FIGS. 1 to 3 is outlined in what follows.

Since, as has been said, the external component 1 is in this case transparent, it will have to be formed first given that otherwise, i.e., if the internal component 2 were initially formed, its colouring could spread into areas that must instead be necessarily kept perfectly transparent and clear: this would irremediably damage the quality and aesthetic appearance of the product. Taking into account the dimensions and of the high aesthetic characteristics that must be obtained by the production of the article according to FIGS. 1 to 3, each step of injection of the plastic material of one and the other component 1, 2 will be normally combined with a step of compression (or possibly of expansion-compression). It should, however, be pointed out that to produce products of less noble quality and characteristics or of modest dimensions, forming of one and/or of the other component may be obtained also by means of simple injection.

In the initial step, represented in FIG. 4, the mould 12 is open and set at a distance from the countermould 11 by an amount Gl that will then serve for carrying out the compression step. Alternatively, it will be kept closed in the case of simple injection, as well as in the case of expansion-compression and then open by the same amount during the injection step.

One or more injectors 14 for injection within the cavities 10 of the material that is to constitute the external component 1, possibly controlled in sequence, are positioned in an area that will subsequently be—as will be seen—coated with the second component 2. In this way, the witness marks of the points of injection of the first component 1 will then be hidden on the outside.

The mobile part 16 is retracted within the recess 18, in the way represented in FIG. 4, so that it rests against the bottom of said recess 18 to be able to withstand the thrust of the material that will be injected. The mobile ring nuts 13 for sealed closing of the cavity 10 are activated to remain in contact with the countermould 11. The injectors 14 are then activated, so as to introduce the plastic material of the external component 1 within the cavity 10, whilst the injectors 15 remain inactive.

Following upon or in the course of the injection step, the mould 12 is re-closed against the countermould 11, carrying out compression of the material injected within the cavity 10. The ring nuts 13 for closing the cavity 10, albeit remaining pushed against the countermould 11, retract until this is completely closed against the mould 12.

After an appropriate time for cooling, the external component 1 is formed.

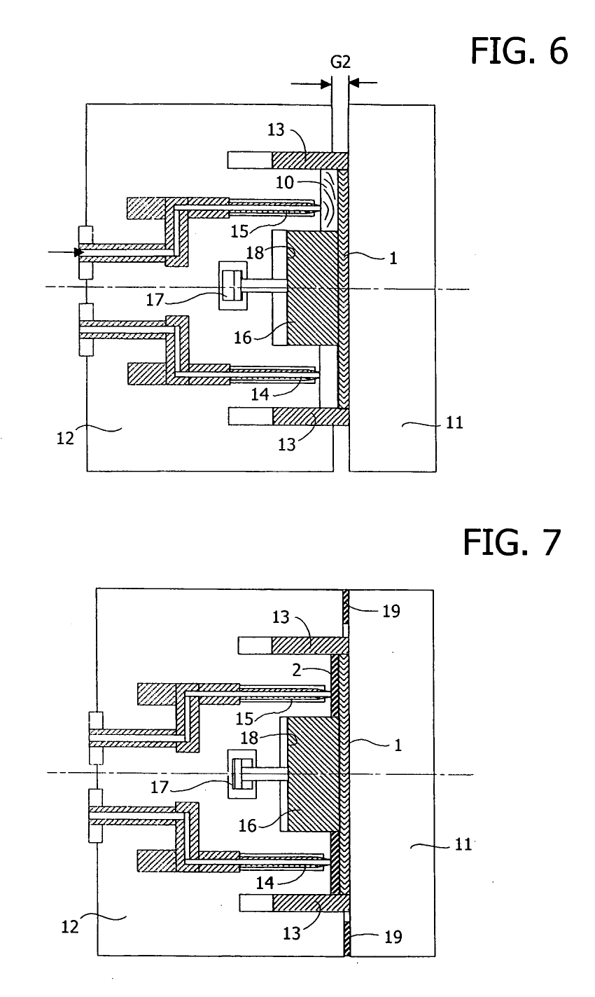

The subsequent step, represented in FIG. 6, envisages first of all activation of the actuator 17 to control partial extraction of the mobile part 16 with respect to the recess 18, whilst simultaneously the mould 12 is moved away from the countermould 11 by an amount G2 corresponding to the sum of the final thickness of the internal component 2 and of the opening desired for the possible compression. This opening could also be made after activation of the injectors 15 for injection of the material of the internal component 2 within the cavity 10, in the case where the technique of expansion-compression is used.

In this way, the previously moulded external component 1 moves away from the mould 12, and the injection of the material of the internal component 2 is performed within the cavity 10 by means of activation of the injectors 15, whilst the injectors 14 remain inactive. It should be pointed out that in this step the positioning of the mobile part 16 and the degree of its thrust against the external component 1 will have to be controlled with precision, in such a way as to modify the conformation of the cavity 10 that is to receive the material of the internal component 2, without, however, any risks of damage to the external component 1.

Before completing or even before starting the compression step, it is advisable to insert between the mould 12 and the countermould 11 inserts 19 for blocking re-closing of the mould 12 so as to guarantee that the desired thickness of the internal component 2 is reached within the tolerances irrespective of the characteristics of the press or of other devices of the moulding apparatus.

At the end of closing of the mould 12, the configuration is the one represented in FIG. 7: once an appropriate time for cooling of the finished piece has elapsed, with the internal component 2 overmoulded along the perimeter of the external component 1, the article can be extracted with altogether conventional modalities, via extraction devices, which are not illustrated in so far as they are within the reach of the person skilled in the branch.

The process described above, can typically be implemented in the case where the external component 1 is transparent, enables evident undoubted advantages to be achieved as compared to processes for obtaining similar articles with the use of the conventional apparatus with dual station and rotation of the countermould from one station to the other. As compared to the traditional technique of moulding with movements with the mould closed, undoubted simplifications of all the movements are achieved, above all at the points of injection, and conditions of resting of the mobile parts are obtained that enable the thrust of the injection to be well withstood without any particular internal devices.

From a constructional standpoint, it may be noted that the mobile mould 12 is in optimal conditions for moulding the transparent external component 1, given that there are no problems in withstanding the thrust of the plastic material during injection and possible subsequent compression. Furthermore, during moulding of the internal component 2, problems of dimensional tolerances and of fits between mould 12 and the countermould 11 are eliminated, given that nothing changes with respect to the preceding step of forming of the external element 1. The only parameter that it is necessary to control and regulate is the thrust with which the mobile part 16 rests against the external component 1 previously formed.

Furthermore, the construction of the moulding apparatus as a whole is appreciably less costly, in addition to being more compact, as compared to the dual-station apparatus with rotating mould.

On the other hand, the methodology consisting in injecting first of all the transparent component 1 could lead to problems as regards construction of the fixing elements 3 and stiffening elements 4 at the moment of the subsequent forming of the internal component 2. As will be seen in what follows, this problem can be solved brilliantly by closing, during moulding of the transparent component 1, the recesses of the mould 12 provided for formation of said fixing elements 3 and stiffening elements 4. For the moment it is anticipated that, from the practical standpoint, said closing can be obtained with mobile parts, for example hydraulically actuated ones, or with the aid of closing elements or else film, or with other solutions that will be described in greater detail in what follows.

As compared to methodologies that use a dual station and rotating mould, a modest or substantially negligible lengthening of the cycle time for producing the entire article may be considered. In fact, in the apparatus with dual station and rotating mould complete superposition of the two steps (injection or injection-compression of the external component 1 on the one hand, and overmoulding by injection and possible compression of the internal component 2 on the external component 1 previously formed, on the other hand) cannot be obtained. In practice, the cycle times in the one case and in the other are practically the same.

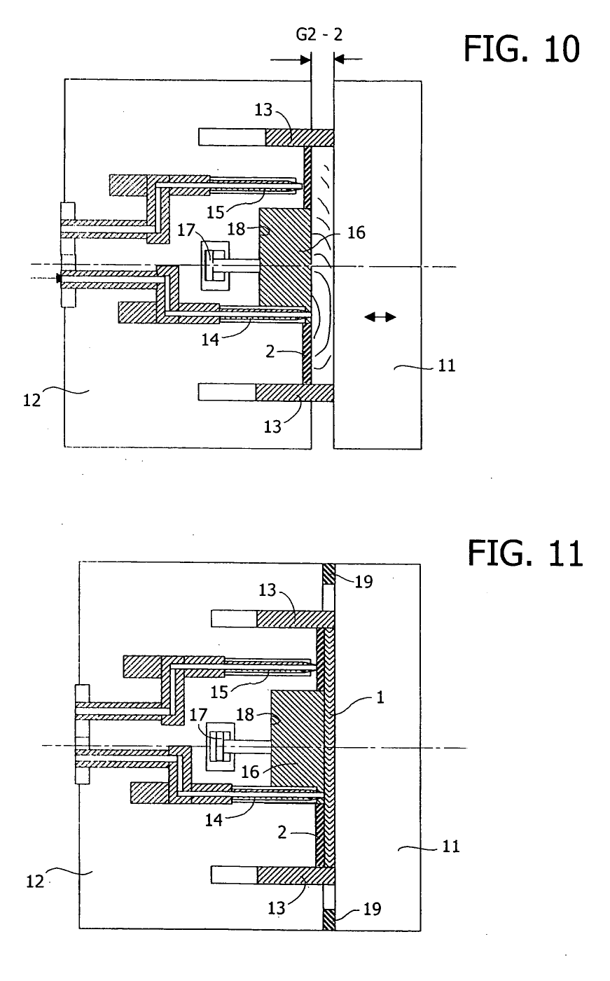

With reference to FIGS. 8 to 11, there now follows a description of the modalities of embodiment of the process according to the invention in the case where the external component 1 of the article to be moulded is not transparent. In this case, it is possible to form first of all the internal component 2 with the corresponding fixing elements 3 and the possible stiffening elements 4, then overmoulding thereon the external component 1, thus covering and hiding possible shrinkage cavities present on the internal component 2.

With initial reference to FIG. 8, in which the parts that are identical or similar to the ones already described with reference to FIGS. 4-7 are designated by the same reference numbers, the injector or injectors 14 for injection of the plastic material of the external component 1 in the cavity 10 are in this case inserted through the mobile part 16 or in any case in an area that, after injection of the material of the internal component 2, will enable introduction of the material of the external component 1 within the modified cavity 10. Since, however, as has been said, the external component 1 is not in this case transparent, this does not constitute a problem.

The moulding cycle is described in what follows.

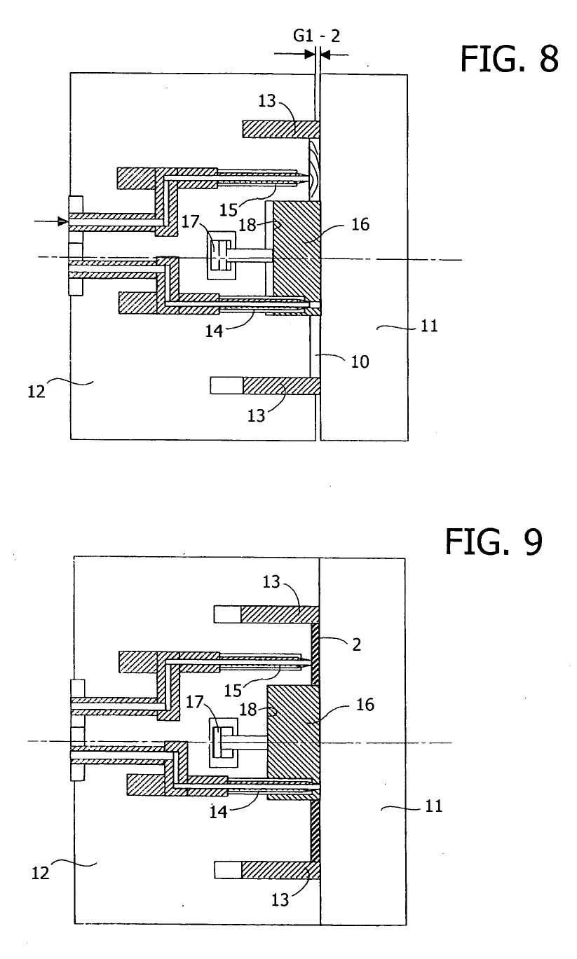

In the first step (represented in FIG. 8), the mould 12 is opened by an amount G1-2 corresponding to the possible stroke of compression associated to the injection, or else it will be kept closed to carry out just injection or else the step of expansion during injection, which will then be followed by the compression step. The central part 16 is pushed via the actuator 17 against the countermould 11 with a controlled force, which also in this case will be the least possible to guarantee closing of the cavity 10 without damaging the surface of the mould 11. Said part 16 then slides with respect to the injector or injectors 14, and the ring nuts 13 for closing the cavity 10 are activated and kept in contact with the countermould 11. The plastic material of the internal component 2 is then injected within the cavity 10 through the injector or injectors 15, and the compression step is carried out to form the internal component 2, in the way represented in FIG. 9. In this step, the internal part 16 and the closing ring nuts 13 retract, pushed by the mould 12.

After an appropriate time for cooling, the mould 12 is re-opened by an amount G2-2 corresponding to the sum of the final thickness of the external component 1 and of the stroke desired for the possible compression. In the case of expansion-compression, opening of the mould 12 will be carried out after start of the injection step. The central mobile part 16 is kept in the retracted position, and the closing ring nuts 13 remain active.

The material of the external component 1 is then injected through the injector or injectors 14, and compression is then performed by approaching the mould 12 to the countermould 11, after inserting between them adjustment inserts 19 corresponding to the final desired thickness of the external component 1, in the way represented in FIG. 11.

After appropriate time for cooling, the mould 11 can be re-opened, and the finished article can be taken out.

With the process described above, there are no problems regarding possible shrinkage cavities in the internal component 2 due to the formation of the fixing elements 3 and the possible stiffening elements 4, given that said shrinkage cavities are, as has been said, then covered by the external component 1, and the visible surface of the article will present in any case aesthetic characteristics of high quality. As a result, it may no longer be necessary to cover and close the recesses of the mould 12 corresponding to said fixing elements 3 and/or stiffening elements 4.

Also in this case, as in the case of the process described with reference to FIGS. 4 to 7, forming of the article is carried out in a single station, without any need for moving the first moulded component towards a second station for moulding the second component. The overall dimensions and the costs of the moulding apparatus are in this way appreciably reduced.

In this case, attention should, however, be paid to the fact that, by opening and then partially re-closing the mould 12 against the countermould 11 (up to the amount defined also in this case by the blocking inserts 19) to carry out injection of the internal component 2, said countermould 11 is set resting against the mobile part 16 precisely in the area in which the so-called “aesthetic” part of the first component 1 will subsequently be moulded.

A first simple solution to obtain said result consists in setting between the surfaces of mutual contact of the countermould 11 and of the mobile part 16 a film, in a way similar to what occurs in the case of conventional moulding with the so-called IMD (In-Mould-Decoration), IML (In-Mould-Labelling) and FIM (Film-Insert-Moulding) techniques.

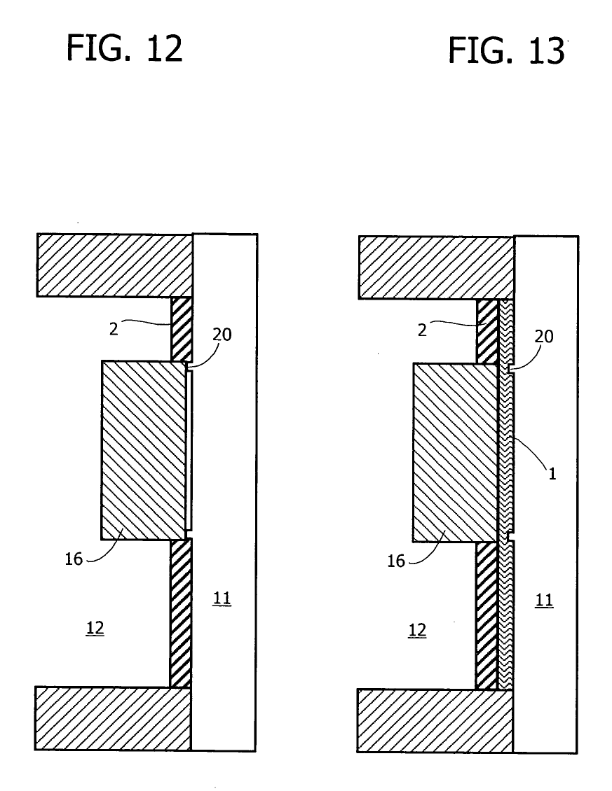

Alternatively, it is possible to envisage the solution schematically represented in FIGS. 12 and 13: the surface of the countermould 11 that is to come into contact with the mobile part 16 can be delimited by a rim in relief 20 projecting within the cavity 10, even of a modest thickness, provided that this is allowed by the aesthetic requirements of the finished article, given that in this case, on the visible surface of the external component 1, a lowered trace corresponding to said rim 20 will be generated.

It should be noted that both in the case of implementation of the process according to the invention with the modalities described with reference to FIGS. 4 to 7, and in the case of implementation with the modalities described with reference to FIGS. 8 to 11, should the injection steps be combined with a compression, it will be possible to use either totally or in part solutions described and illustrated in the prior Italian patent applications Nos. cited previously T02004A000696, T02004A000697, T02004A000698, T02004A000699, T02004A00700, T02004A000701, T02004A000702, T02004A000703, T02004A000716 and T02004A000813, the contents of which must be understood as being incorporated herein for immediate reference.

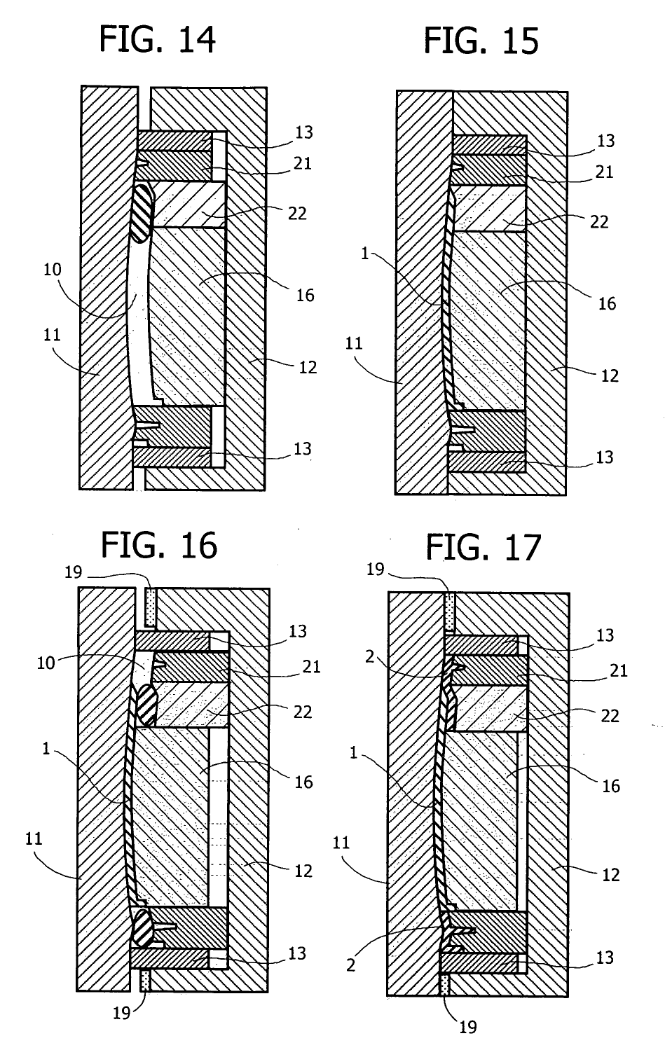

FIGS. 14 to 30 illustrate different examples, in which the cavity 10 can be further modified by means of other mobile elements carried by the mould 12.

The example represented in FIGS. 14 and 17 as regards the different successive moulding steps refers to the case where the internal component 2 is overmoulded, with modalities generally corresponding to what has already been described with reference to FIGS. 4 to 7, not only underneath but also on the sides of the internal component 1. In the case in point, a second mobile part 21 is provided having an annular shape, and a stationary insert 22 is set in an area between of the mobile parts 16 and 21. The steps of moulding of the bi-component article are in this case described in what follows.

Initially (FIG. 14), the mould 12 is opened with respect to the countermould 11 by the amount necessary for carrying out the compression step, and the plastic material of the external component 1 is introduced into the cavity 10, keeping the mobile part 16 retracted and setting the mobile part 21 in an advanced position, via a purposely provided actuator (not illustrated), for example similar to the actuator 17 associated to the mobile part 16. The mould 12 is then re-closed in the compression step (FIG. 15), whilst the annular mobile part 21 is made to retract. Then, the mould 12 is re-opened, keeping the mobile part 21 in a retracted position and causing the mobile part 16 to advance against the internal component 1 previously moulded, and the material of the internal component 2 is then injected in the cavity 10 thus modified (FIG. 16). Following upon introduction of the blocking inserts 19, the mould 12 is re-closed to carry out the compression step, thus forming the internal component in the way illustrated in FIG. 17.

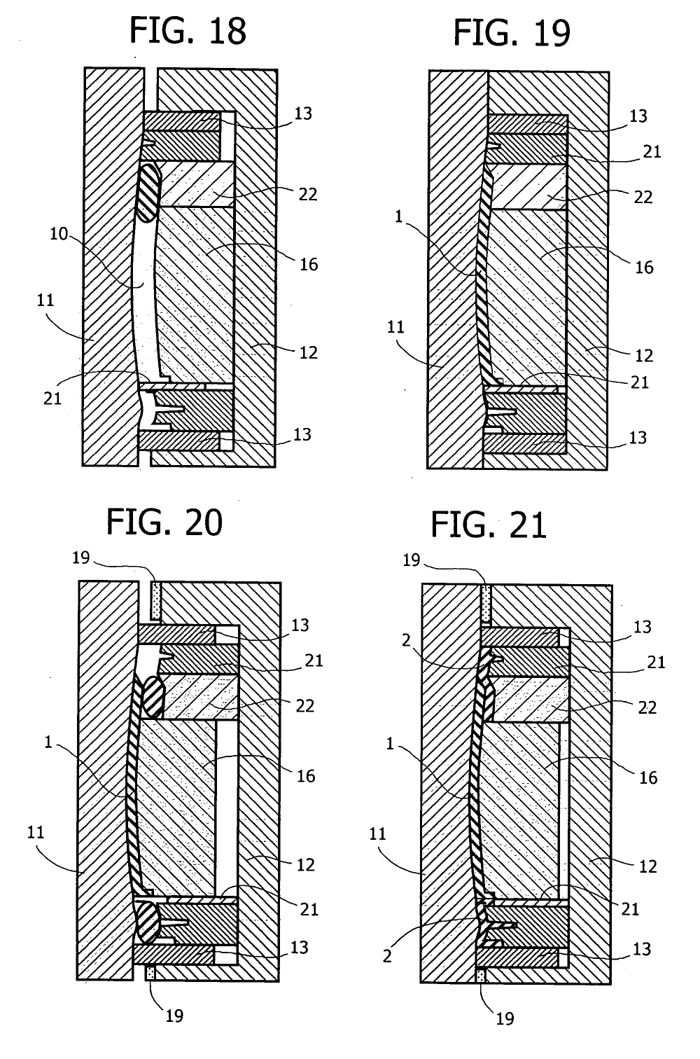

The arrangement is similar to that of the case represented in FIGS. 18 to 21, in which parts that are identical or similar to the ones described with reference to FIGS. 14 to 17 are designated by the same reference numbers. In this case, the mobile part 21 locally has limited dimensions, and hence is less subject to the thrust of the injected material, and the internal component 2 is formed in the configuration illustrated in FIG. 21. The subsequent moulding steps represented in FIGS. 18 to 21 correspond to the ones described with reference to FIGS. 14 to 17.

The examples described above are not of course exhaustive, in so far as the conformation of the internal component 2 overmoulded on the external component 1 may be extremely varied and even complex, either with perimetral edges or not, or else also just in the form of a small part overmoulded on the external component 1 that will enable formation of the fixing elements 3.

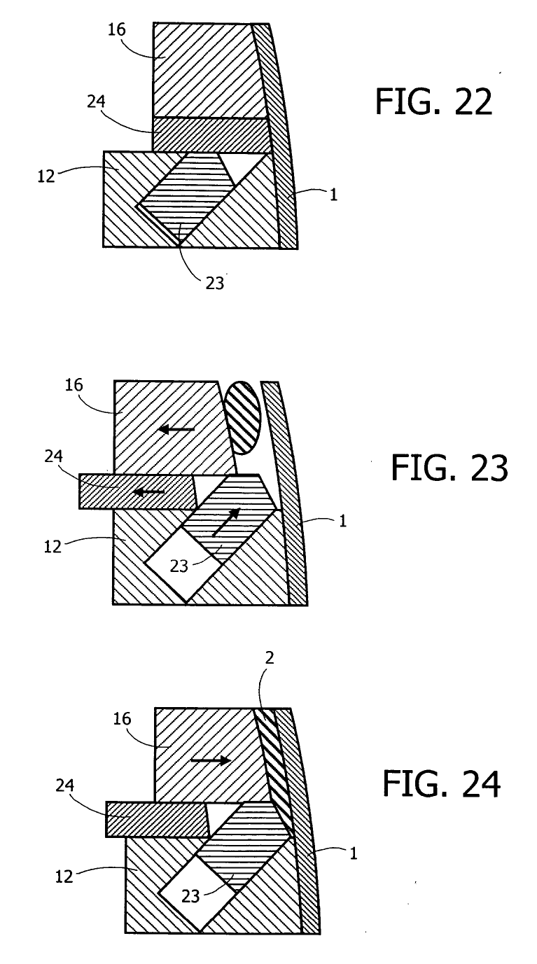

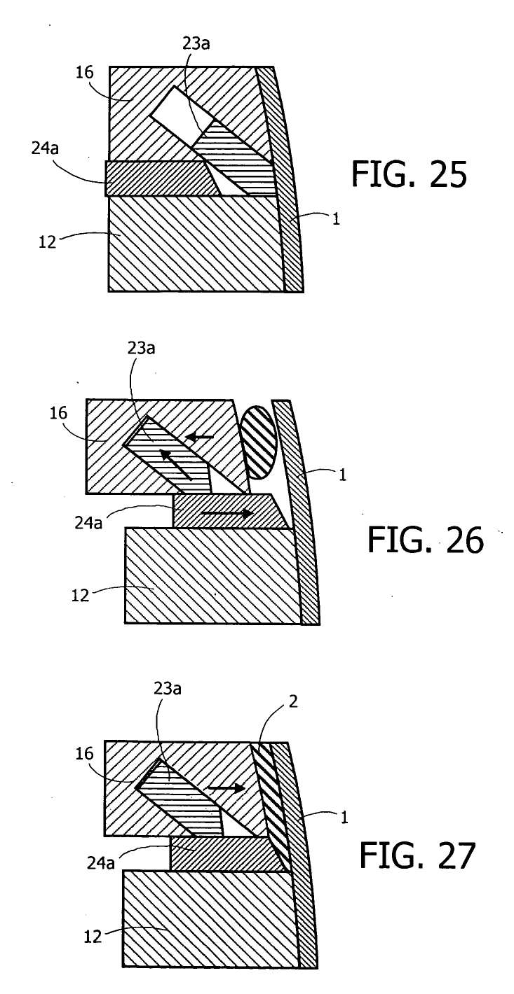

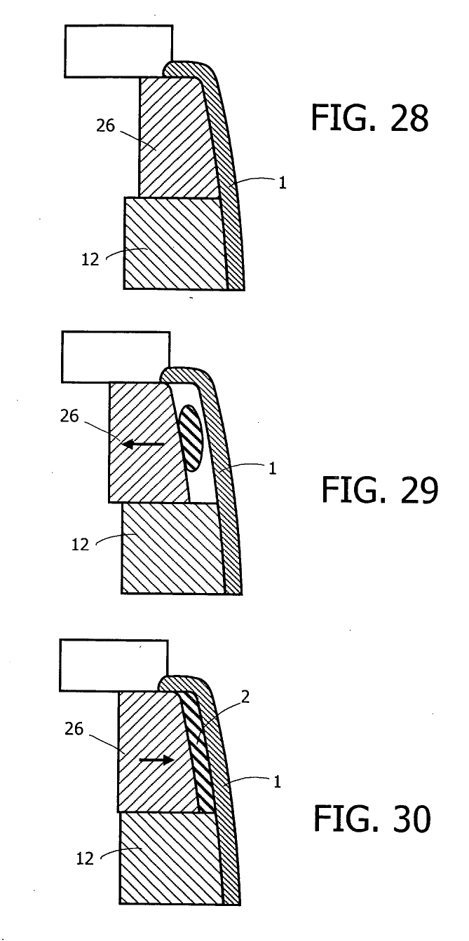

FIGS. 22-24, 25-27 and 28-30 show some examples of more complex shapes that can be obtained using further localized and generally de-centred mobile parts, which are also carried by the mould 12. Thus, in the case of FIGS. 22-24, the further mobile parts 23 and 24 enable overmoulding of the internal component 2 with chamfered parts or reinforcement ribs, or else with further fixing elements, as likewise the mobile parts 23a and 24a represented in FIGS. 25-27 along with the corresponding movements that they can perform. In the case of FIGS. 28 to 30, the further mobile part designated by 26 enables the external component 1 to be obtained with a curved side edge and then overmoulding in said area of the internal component 2. It should be noted that, in the case where the dimensions of the internal component 2 to be overmoulded on the external component 1 are modest in proportion to the entire extension of the article, the step of compression of the plastic material injected for formation of said internal component 2 may be carried out with internal movements, without any need to move the entire mould 12.

Also in these cases, then, the peculiarity of the invention consists in preventing rotation of the countermould 11 about a vertical axis or horizontal axis to bring the external moulded component 1 into a subsequent station for overmoulding the internal component 2 by conveniently exploiting an opening of the press and a thickness of mould that is different between the first and second steps.

With the solutions described above, it is therefore possible to overcome any drawback that could derive from the fact that the mould 12 used to form the external component 1 is the same that must then overmould the internal component 2. The limitations resulting from variations in geometry between the internal component 2 and the external component 1 are overcome by the possibility of providing internal movements that will modify the cavity 10 before injection of the material for the overmoulded component.

It should be noted that, as on the other hand has already been clarified, the examples described with reference to the drawings are only some of an infinite multiplicity of possible embodiments of the apparatus for implementation of the process according to the invention. Listed hereinafter are some of the possible variant embodiments that may be envisaged in the framework of the invention.
1. The moulded item may be not only plane, but also curved and with more or less complex shapes.
2. The injection can be performed not only directly, but also with conventional technologies of the film type or tunnel type, etc., and also with sequential modalities.
3. The mobile ring nuts 13 associated to the mould 12 for keeping the cavity 10 closed can possibly be positioned on the countermould 11, in the case where this were constructionally more convenient or more advisable according to the conformation of the article to be moulded.
4. The injectors 14 and 15 for injection of the material of the external component 1 and of the material of the internal component 2 can be positioned in a way different from what is represented in FIGS. 4 to 11.
5. The devices for actuation of the mobile parts 16, 21, 23-24, 23a-24a, 26 previously described have not been illustrated or described in detail in so far as they may indifferently be of an electrical, mechanical, hydraulic or pneumatic type, in any case, within the reach of the person skilled in the branch.
6. Nor has the extraction part of the apparatus been illustrated and described in detail, in so far as it can be obtained according to traditional systems and without any constraint.
7. Even though in FIGS. 4 to 11 only one injector 14 for the external component 1 and one injector 15 for the internal component 2 have been illustrated, a multiple-point injection may be provided for both of the components, possibly controlled in sequence as in the case of the already cited Italian patent application No. T02004A000700.
8. Even though, in the foregoing description, it is envisaged to carry out both moulding of the first component and overmoulding of the second component by means of injection-compression, application of the compression step for one of the components only or else application of the technique of injection with expansion-compression for one or both of the components is possible and foreseeable in the framework of the invention, and even in the case where no injection-compression step is envisaged, opening the mould by an amount equal to the thickness to be moulded may conveniently be exploited. Opening can be obtained by the press or else by elements operatively connected to the mould itself.
9. The plastic materials used for the first and second components (as well as for possible further components overmoulded on the first component) may be extremely varied, transparent or not, and also different compositions may be used in the case where some areas of the article are to be painted, decorated or coated with a film using an IMD technique or the like.
10. It is also possible to contemplate use of gas and/or liquid for emptying out the hollow sections.
11. As has already repeatedly been clarified, the external component 1 is not necessarily transparent, and also in the case where it is not transparent, moulding of the article may be simplified by application of the procedure described previously with reference to FIGS. 8 to 11.
12. In particular situations, the procedure described with reference to FIGS. 8 to 11 may be applied also in the case where the external component 1 is transparent, for example in the case where the following situations arise:
   there exists an area convenient for injection of the transparent material, which for other reasons is then hidden;
   the visibility of the injection point or points is acceptable from the aesthetic standpoint;
   a film injection is used, and the possible spreading of the material—which is generally black in colour—that constitutes the internal component 2 is not visible;
   the internal component 2 is overmoulded only on limited areas of the external component 1, and it is possible to control any possible spreading of colour in an acceptable way;
   the coupling together of the two materials that constitute the external component 1 and the internal component 2 is such that in any case no spreading of colour occurs.

As already previously anticipated, in the implementation of the process according to the invention in conformance with what was described with reference to FIGS. 4 to 7, i.e., in the case where the external component 1 (transparent or not) is first moulded, and then the internal component 2 is overmoulded, there may arise problems as regards formation of the fixing elements 3 and/or stiffening elements 4 at the moment of overmoulding of the internal component 2. To solve this possible problem, the invention envisages closing the recesses of the countermould 12 provided for formation of said fixing elements 3 and/or stiffening elements 4, using by way of example different modalities illustrated in the drawings: with the use mobile parts, which can be displaced via actuators, with a three-position extraction, with the aid of a covering film, or with similar equivalent systems.

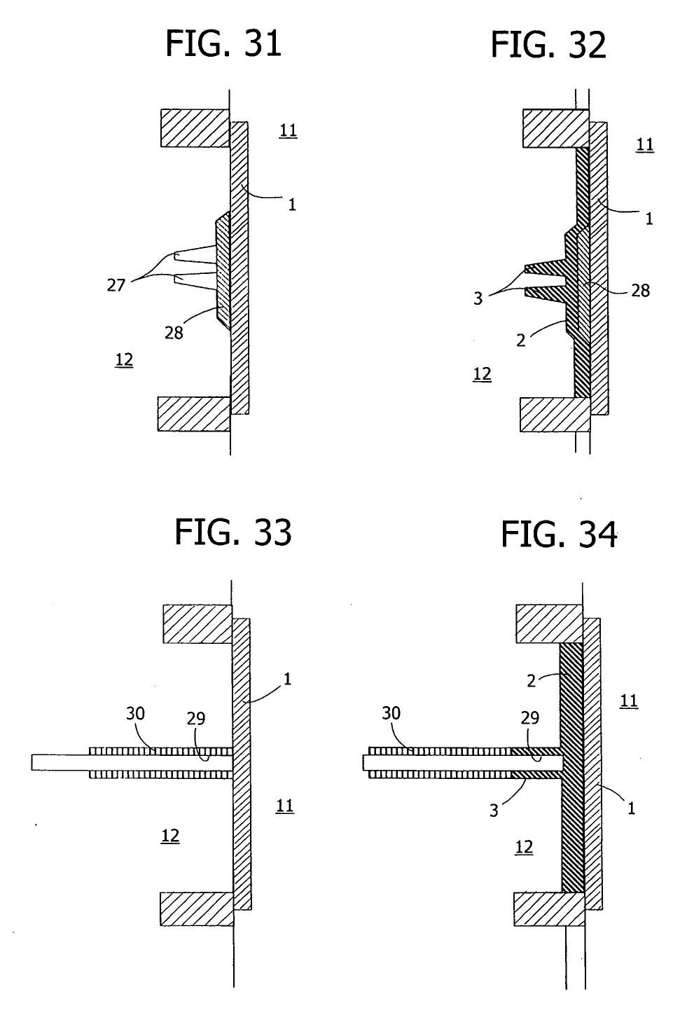

FIGS. 31 and 32 show an example of modality of closing of recesses 27 of the mould 12 that are to form projections 3 for attachment of the internal component 2, via a covering element 28. Said covering element 28 can be constituted by a thin film or else—as in the case represented precisely in FIGS. 31 and 32—by a body having a certain thickness and thus sufficiently robust to withstand the pressure of injection and possible compression of the external component 1. The covering element 28 is welded on the internal surface of the external component 1 during moulding of the latter (FIG. 31) and will move away with this from the mould 12 prior to injection of the internal component 2 so that the corresponding injected material can coat the covering element 28 and fill the recesses 27 to form the attachment element 3 (FIG. 32). It is convenient for the covering element 28 to be chamfered to favour sliding of the material of the internal component 2, or else for its thickness to be substantially smaller than what is envisaged for said internal component 2.

Alternatively, the covering element 28 could be already pre-formed with the attachment element 3 and introduced as insert within the cavity 10 and then be englobed in the internal component 2. In this case, the covering element 28 would be more complex, but could also be made of metal or of a material with high resistance, and also present more complex shapes.

A further alternative for obtaining closing of the recesses corresponding to the attachment elements 3 and/or stiffening elements 4 during moulding of the external component 1 can consist in the use of an appropriately shaped extractor, as illustrated in FIGS. 33 and 34. In this case, the recess of the mould 12 for formation of the attachment element 3, designated by 29, will present a tubular conformation corresponding to that of the tubular extractor 30, which will be kept in an advanced position flush with the cavity 10 during moulding of the external component 1 (FIG. 33) and will then be partially retracted so as to free a portion of the recess 29 that will then be occupied by the material of the internal component 2 at the moment of its moulding (FIG. 34). Of course, in the retracted position illustrated in FIG. 33, the tubular extractor 30 will have to be pre-arranged so as not to retract under the thrust of the pressure of injection and subsequent possible compression of the material of the external component 1.

All the lines of joining or minor defects due to the presence of radiusing, errors of alignment, etc., will be in this case coated with the material of the internal component 2, and will not be visible from outside even in the case where the external component 1 is transparent.

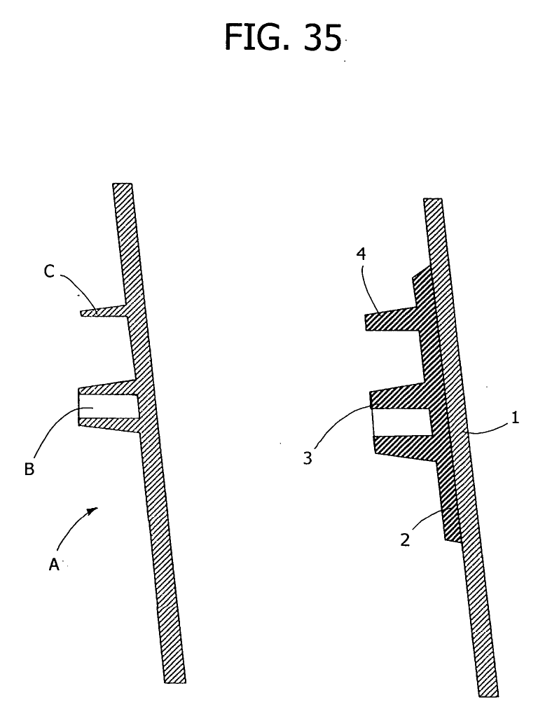

With the solutions described above, the fixing elements 3 and the possible strengthening elements 4 of the internal component 2 may be obtained with substantial thicknesses and in any case much greater than with conventional injection systems, as illustrated schematically in FIG. 35, where represented in the right-hand part is an article obtained according to the invention generally in accordance with the methodology described above with reference to FIGS. 31 and 32, and represented in the left-hand part is a similar article produced with conventional procedures, without overmoulding of the internal component 2. Said conventional article, designated as a whole by A, will typically present aesthetic defects in the areas of forming of the corresponding attachment element B and strengthening element C.

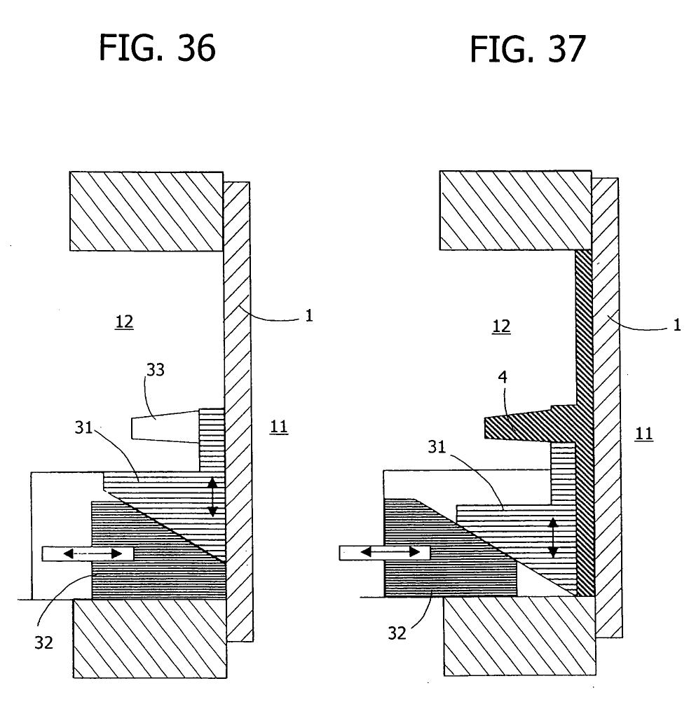

A further methodology for obtaining closing of the recesses of the mould 12 provided for forming fixing elements 3 and/or strengthening elements 4 of the internal component 2 overmoulded on the external component 1, consists in providing within the mould 12 mobile closing parts. An example in this sense is represented in FIGS. 36 and 37. In this case, a mobile part 31, moved for example by a wedge 32, which is in turn actuated by a motor-driven actuator (not illustrated), operates so as to close a recess 33 of the mould 12 during moulding of the external component 1 and re-open said recess 33 to enable introduction of the material of the internal component 2 when this is overmoulded on the external component 1 so as to form a strengthening rib 4. With respect to the case described with reference to FIGS. 33 and 34, this solution enables provision of a partial extraction of the strengthening rib 4, substantially as in the case described with reference to FIGS. 31 and 32 in which the extraction can be complete.

It should be noted that the techniques of closing described above with reference to FIGS. 31-37 can find advantageous generalized application also to cases in which the bi-component article is obtained by means of simple injection, or else by means of injection-compression or else again via injection-expansion-compression, also with the use of conventional apparatus with rotation of the mould between two stations, and also in all or in part with the methodologies described and illustrated in the Italian patent applications already cited previously.

Of course, the details of construction of the apparatus and the modes of implementation of the process may vary widely with respect to what is described and illustrated herein, without thereby departing from the scope of the present invention as defined in the ensuing claims.

1. A process for the production of an article made of moulded plastic material with a first component and at least one second component overmoulded on the first component, including:
a first injection step to form said first component within a cavity defined between a mould and a countermould;
a geometrical variation of said cavity; and then a second step of injection of said second component for overmoulding thereof on the first component,
said process being carried out in a single station defined by said mould and said countermould and said geometrical variation of the cavity includes a step of recession between said mould and said countermould.

2. The process according to claim 1, wherein said geometrical variation of said cavity further includes the displacement therewithin of at least one mobile part of said mould.

3. The process according to claim 1, wherein at least one of said first and second injection steps includes a compression step.

4. The process according to claim 1, wherein at least one of said first and second injection steps includes a step of expansion and subsequent compression.

5. The process according to claim 2, wherein said at least one mobile part is kept in a retracted position within said mould during formation of said first component within said cavity, and is displaced into an advanced position against said first component to modify said cavity for overmoulding said second component.

6. The process according to claim 5, wherein said first component is transparent.

7. The process according to claim 2, wherein said mobile part is kept in an advanced position against said countermould during formation of said first component and is displaced into a retracted position with respect to said countermould to modify said cavity for overmoulding said second component.

8. The process according to claim 7, wherein said second component is not transparent.

9. The process according to claim 1, in which said second overmoulded component includes at least one projecting element of at least one of attachment and reinforcement of said article formed within a corresponding recess of said mould, wherein prior to forming said first component said recess is closed.

10. The process according to claim 9, wherein said recess is closed by a covering means that adheres to said first component and is then englobed in said second component.

11. The process according to claim 9, wherein said recess is closed by a covering film.

12. The process according to claim 9, wherein said recess is closed and then re-opened using extractor means.

13. The process according to claim 9, wherein said recess is closed and then re-opened by mobile parts.

14. The process according to claim 1, further including the movement of further mobile parts to modify locally areas of said cavity prior to overmoulding of said second component.

15. A moulding apparatus for the production of an article made of moulded plastic material with a first component and at least one second component overmoulded on said first component, comprising: a mould and a countermould defining therebetween a moulding cavity; injection means for injecting within said cavity, respectively in a first and in a subsequent second injection step, the material of said first component and the material of said second component; and means for geometrical modification of said cavity following upon said first injection step, wherein said apparatus includes a single station, defined by said mould and said countermould, for carrying out said first and second steps, and said means for modifying the cavity following upon said first step include the mould itself, which can be moved away relative to said countermould.

16. The apparatus according to claim 15, wherein said means for modifying the cavity following upon said first step include at least one mobile part of said mould, which can be displaced within said cavity.

17. The apparatus according to claim 15, further including compression means for carrying out a compression step combined with at least one of said first and second injection steps.

18. The apparatus according to claim 15, further including expansion/compression means for carrying out a step of expansion and subsequent compression associated to at least one of said first and second injection steps.

19. The apparatus according to claim 16, wherein said at least one mobile part is able to slide within a recess of said mould via motor-driven actuator means.

20. The apparatus according to claim 19, wherein said at least one mobile part is set in a position substantially corresponding to an area of said cavity to which there corresponds an area of said first component on which said second component is not overmoulded during said second step.

21. The apparatus according to claim 16, including a plurality of mobile parts of said mould which can be displaced within said cavity.

22. The apparatus according to claim 16, wherein said countermould has an annular projection projecting within said cavity for resting of said at least one mobile part.

23. The apparatus according to claim 15, in which said mould has at least one recess for formation of at least one of fixing elements and stiffening elements integral with said second component and is further provided with closing means for closing said recess during said first injection step.

24. The apparatus according to claim 23, wherein said closing means comprises a covering element designed to adhere to said first component and to be englobed within said second component.

25. The apparatus according to claim 24, wherein said covering element comprises a film.

26. The apparatus according to claim 24, wherein said covering means consist of element comprises an extractor which can be displaced in said mould between an advanced position for closing and a retracted position for opening said recess.

27. The apparatus according to claim 23, wherein said closing means include mobile parts which can be displaced in said mould between an advanced position for closing and a retracted position for opening said recess.

28. The apparatus according to claim 15, further including means of arrest which can be set between said mould and said countermould to limit an approach of said mould with respect to said countermould.

29. A process for the production of an article made of moulded plastic material with a first component and at least one second component overmoulded on the first component, including:
a first injection step to form said first component within a cavity defined between a mould and a countermould; and
a second step of injection of said second component for overmoulding thereof on said first component;
wherein at least one of said first and second injection steps includes a compression step and said process is carried out in a single station defined by said mould and said countermould.

30. The process according to claim 29, including a geometrical variation of said cavity between said first and second steps.

31. The process according to claim 30, wherein said geometrical variation of the cavity includes a step of recession between said mould and said countermould.

32. The process according to claim 30, wherein said geometrical variation of said cavity moreover includes the displacement therewithin of at least one mobile part of said mould.

33. The process according to claim 30, wherein both of said first and second injection steps include a compression step.

34. The process according to claim 30, wherein at least one of said first and second steps includes a step of expansion and subsequent compression.

35. The process according to claim 32, wherein said at least one mobile part is kept in a retracted position within said mould during formation of said first component within said cavity, and is displaced into an advanced position against said first component, modifying said cavity for overmoulding said second component.

36. The process according to claim 35, wherein said first component is transparent.

37. The process according to claim 32, wherein said mobile part is kept in an advanced position against said countermould during formation of said first component and is displaced into a retracted position with respect to said countermould to modify said cavity for overmoulding said second component.

38. The process according to claim 37, wherein said second component is not transparent.

39. The process according to claim 29, in which said second overmoulded component includes at least one projecting element of at least one of attachment and reinforcement of said article formed within a corresponding recess of said mould, wherein prior to forming said first component said recess is closed.

40. The process according to claim 39, wherein said recess is closed by a covering element that adheres to said first component and is then englobed in said second components.

41. The process according to claim 39, wherein said recess is closed by a covering film.

42. The process according to claim 39, wherein said recess is closed and then re-opened using extractor means.

43. The process according to claim 39, wherein said recess is closed and then re-opened by mobile parts.

44. The process according to claims 29, further comprising the movement of further mobile parts to modify locally areas of said cavity prior to overmoulding of said second component.

45. A moulding apparatus for the production of an article made of moulded plastic material with a first component and at least one second component overmoulded on said first component comprising: a mould and a countermould defining therebetween a moulding cavity; injection means for injecting within said cavity, respectively in a first and in a subsequent second injection step, the material of said first component and the material of said second component; and compression means for carrying out a compression step combined with at least one of said first and second injection steps,
wherein said apparatus includes a single station, defined by said mould and said countermould, for carrying out said first and second injection steps and said compression step.

46. The apparatus according to claim 45, further comprising means for geometrical modification of said cavity following upon said first injection step.

47. The apparatus according to claim 46, wherein said means for modifying the cavity following upon said first step include the mould itself, which can be moved away from said countermould.

48. The apparatus according to claim 46, wherein said means for modifying the cavity following upon said first step include at least one mobile part of said mould which can be displaced within said cavity.

49. The apparatus according to claim 45, comprising compression means for carrying out a compression step combined with each of said first and second injection steps.

50. The apparatus according to claim 45, comprising expansion/compression means for carrying out a step of expansion and subsequent compression associated to at least one of said first and second injection steps.

51. The apparatus according to claim 48, wherein said at least one mobile part is able to slide within a recess of said mould via motor-driven actuators means.

52. The apparatus according to claim 48, wherein said at least one mobile part is set in a position substantially corresponding to an area of said cavity to which there corresponds an area of said first component on which said second component is not overmoulded during said second step.

53. The apparatus according to claim 48, including a plurality of mobile parts of said mould, which can be displaced within said cavity.

54. The apparatus according to claim 48, wherein said countermould has an annular projection projecting within said cavity for the resting of said at least one mobile part.

55. The apparatus according to claim 45, wherein said mould has at least one recess for formation of at least one of fixing elements and stiffening elements integral with said second component, wherein it is further provided with means for closing said recess during said first injection step.

56. The apparatus according to claim 55, wherein said closing means comprises a covering element designed to adhere to said first component and to be englobed within said second component.

57. The apparatus according to claim 55, wherein said covering means consist comprises a film.

58. The apparatus according to claim 55, wherein said covering means comprises an extractor which can be displaced in said mould between an advanced position for closing and a retracted position for opening said recess.

59. The apparatus according to claim 55, wherein said closing means include mobile parts which can be displaced in said mould between an advanced position for closing and a retracted position for opening said recess.

60. The apparatus according to claim 47, further including stop means which can be set between said mould and said countermould to limit an approach of said mould with respect to said countermould.
